(19) United States
(12) Patent Application Publication
(10) Pub. No.: US 2007/0176413 A1
(43) Pub. Date: Aug. 2, 2007

(54) Corrosion resistant gas service riser assembly

(75) Inventors: Bryan Lucas, Seminole, OK (US); Tom Veeley, Tecumseh, OK (US)

Correspondence Address: MCAFEE & TAFT;TENTH FLOOR, TWO LEADERSHIP SQUARE, 211 NORTH ROBINSON, OKLAHOMA CITY, OK, 73102, US

(73) Assignee: Central Plastics Company

(21) Appl. No.: 11/341,150

(22) Filed: Jan. 27, 2006

(51) Int. Cl. F16L 9/14

(52) U.S. Cl. 285/55

(57) ABSTRACT

The present invention provides improved gas service riser assemblies. The improved gas service riser assemblies utilize an adapter to provide the transition from the plastic pipe used for underground distribution of natural gas to the metal pipe used in above ground natural gas distribution systems. Further, the improved gas service riser assemblies do not utilize the protective metal casing as a conduit for the natural gas thereby reducing the hazards associated with corrosion of the protective metal casing.

### BACKGROUND OF THE INVENTION

The present invention relates to a gas service riser assembly and a metal pipe to plastic pipe transition connection.

Plastic pipe such as polyethylene pipe is now utilized in most gas distribution systems. As a result, there are many applications where plastic pipe must be connected to metal and other forms of pipe. For example, above ground gas meters are generally connected by metal pipe to below ground plastic gas service pipe. The metal pipe and plastic pipe are often joined together by a gas service riser which extends from below ground to a gas meter above ground. Such riser assemblies have heretofore been comprised of a metal pipe which connects to the gas meter and contains a metal to plastic pipe transition connection therein. That is, the riser assembly comprises an outer metal pipe and an inner plastic pipe. The inner plastic pipe extends through and out of the outer metal pipe and the outer metal pipe or casing provides protection to the inner plastic pipe.

In many cases, the metal pipe used in current gas risers also provides the transition from the plastic pipe to the above ground metallic pipe network. As such, the metal pipe must be protected from corrosion. However, the transition zone from plastic to metal pipe commonly requires welding and other operations which damage the corrosion resistant coatings applied to the exterior of the protective metal casing.

FIG. 1 depicts a typical prior art gas riser assembly 10. As shown, a casing 12 carries a corrosion resistant layer of epoxy 14. Since epoxy 14 requires curing at temperatures greater than the melting point of the plastic pipe, epoxy 14 is applied to casing 12 prior to assembly of gas riser assembly 10. The epoxy 14 is applied to the length of casing 12 except for a region 18 adjacent to a first end 20 of casing 12. Region 18 is left blank to permit welding of an adapter nipple 22 to casing 12. In the prior art process, nipple 22 is first secured to plastic pipe 16 followed by positioning of plastic pipe 16 and nipple 22 within casing 12. Thereafter, nipple 22 is welded to casing 12. Following welding, region 18 and nipple 22 are painted. Unfortunately, most paints do not provide a degree of corrosion protection equal to epoxy 14.

Therefore, it would be advantageous to provide a gas riser assembly which utilizes a corrosion resistant or non-corrosive adapter to provide the transition from plastic pipe to the above ground metal pipe system. Further, it would be preferred to provide a gas riser assembly which does not require typical arc, TIG or MIG welding processes on the gas carrying lines for connection to the above ground natural gas distribution pipe.

### SUMMARY OF THE INVENTION

In one embodiment, the current invention provides a corrosion resistant gas service riser assembly. The service riser assembly comprises a corrosion resistant casing having first and second ends with a plastic pipe having first and second ends positioned within the casing. The service riser assembly further comprises an adapter for joining a plastic pipe to a metal pipe. The adapter has a body which carries a nipple and preferably carries a flange. The nipple is secured within the first end of the plastic pipe and the body of the adapter is secured within the first end of the corrosion resistant casing thereby precluding fluid communication between the interior passageway of said plastic pipe and the interior passageway of said casing. Preferably, the adapter is at least substantially non-corrosive. Optionally, a connection ring is secured to the first end of the corrosion resistant casing and the body of the adaptor is secured within the connection ring.

In another embodiment, the current invention provides a corrosion resistant gas service riser assembly. The service riser assembly comprises a corrosion resistant casing having first and second ends wherein the first end includes a bellout area carrying internal threads. A portion of the bellout area may optionally be formed by a connection ring welded or otherwise secured to the first end of the casing. Positioned within the casing is a plastic pipe having first and second ends with the second end of the plastic pipe extending through the second end of the casing. Positioned on the first end of the plastic pipe is a compression sleeve having an internal diameter substantially similar to the external diameter of the plastic pipe. The service riser assembly further comprises an adapter. Preferably, the adapter is at least substantially non-corrosive. The adapter has a threaded body and preferably carries a flange. Additionally, a first nipple extends from the threaded body. The first nipple carries a groove for receiving an o-ring and a plurality of frusto-conically shaped rings. Positioned above the flange is a second nipple which carries external threads. When assembled, the first nipple is positioned within the plastic pipe and secured therein by the compression sleeve. Finally, the threaded body is threaded into the bellout area in a manner suitable to preclude fluid communication between the interior of the casing and the interior of the plastic pipe. In a preferred embodiment, the second nipple carries or is replaced by an integral fitting suitable for joining to an above ground distribution system. Optionally, the threads may be omitted from both the bellout area and the body of the adapter. When the threads are omitted, the body of the adapter is preferably secured within the first end of the casing by either a swaged joint or a magnetic pulse weld joint in a manner suitable to preclude fluid communication between the interior of the casing and the interior of the plastic pipe.

In yet another embodiment, the current invention provides a corrosion resistant gas service riser assembly comprising a corrosion resistant casing having first and second ends. The first end of the casing has a diameter larger than the diameter of the second end and the first end has a configuration corresponding to wrench flats. Additionally, the service riser assembly comprises a plastic pipe having first and second ends positioned within the casing. Preferably, the second end of the plastic pipe extends beyond the second end of the casing. The first end of the plastic pipe carries a compression sleeve having an internal diameter substantially similar to the external diameter of the plastic pipe. Additionally, the first end of the plastic pipe carries a lock ring having a body with an external configuration corresponding to the wrench flats carried by the first end of the casing with the lock ring body being sized to be received within the first end of the casing. The lock ring body extends between a first open end and a second open end. The first open end carries an outwardly extending flange and has an internal diameter greater than the external diameter of the plastic pipe. The second open end has an internal diameter corresponding generally to the external diameter of the plastic pipe. The riser assembly further comprises an adapter for joining a plastic pipe to a metal pipe having an adapter body. The adapter body is sized to be received within the lock ring and has an external configuration corresponding to wrench flats. Additionally, a first nipple extending downwardly from the adapter body is positioned within the plastic pipe and secured therein by the compression sleeve. The adapter body is positioned within the insulated lock ring and secured within the first end of the casing in a manner suitable to preclude fluid communication between the interior of the casing and the interior of the plastic pipe. Preferably, the adapter is at least substantially non-corrosive.

Finally, the current invention provides a method for joining an underground fluid distribution system using plastic to an above ground distribution system formed from metal pipe. The method of the current invention provides a casing having first and second ends and preferably forms a bellout area on the first end of the casing. Additionally, the method provides a plastic pipe having first and second ends and a plastic pipe to metal pipe adapter. The adaptor has a body sized to fit within the casing and the body preferably carries a flange. Extending from the body is a first nipple while on the opposite side of the flange from the first nipple is a fitting suitable for integration with an above ground distribution system. The first nipple is secured within the first end of the plastic pipe and the plastic pipe positioned within the casing. Preferably, the plastic pipe has a length sufficient to extend beyond the second end of the casing. The body of the adapter is also positioned and secured within the first end of the casing in a manner suitable to preclude fluid communication between the interior of the casing and the interior of the plastic pipe. Following assembly of the gas service riser assembly, the second end of the plastic pipe is joined to an underground fluid distribution system and the fitting opposite of the first nipple is directly or indirectly joined to an above ground distribution system.

The present invention provides several advances over the current art. Most current gas service risers utilize at least a portion of the external protective casing as a conduit for the natural gas. Thus, corrosive failure of the casing will result in a gas leak. Further, use of the casing as a conduit requires additional seals between the casing and the plastic pipe. Finally, many gas service riser assemblies require welding of the protective casing. Such welding operations frequently damage the corrosion resistant coating applied to the casing leading to corrosion of the casing.

### BRIEF DESCRIPTION OF THE DRAWINGS

FIG. 1 is a side cutaway view of a prior art gas service riser assembly.

FIG. 2 is a side view of a gas service riser assembly of the current invention.

FIG. 3 is a detailed view of the first end of the corrosion resistant casing.

FIG. 4 is a detailed viewed of the corrosion resistant gas service riser depicting the first end of the corrosion resistant casing with the adapter positioned therein.

FIG. 5 is a side cutaway view of the corrosion resistant gas service riser depicting the first end of the corrosion resistant casing with the adapter positioned therein.

FIG. 6 depicts an alternative embodiment of the current invention wherein the adapter includes an integral fitting.

FIG. 7 is a side cutaway view of the embodiment depicted in FIG. 5.

FIG. 8 is a side view of another embodiment of the current invention.

FIG. 9 is a side view of the embodiment depicted in FIG. 7 in the assembled format.

FIG. 10 is a side cutaway view of the invention depicted in FIG. 7.

FIG. 11 depicts another embodiment of the current invention.

FIG. 12 is a side view of the embodiment depicted in FIG. 10 in the assembled configuration.

FIG. 13 is a side cutaway view of the invention depicted in FIG. 10.

FIG. 14 depicts yet another embodiment of the current invention.

FIG. 15 depicts a side cutaway view of the embodiment depicted in FIG. 13 in the assembled format.

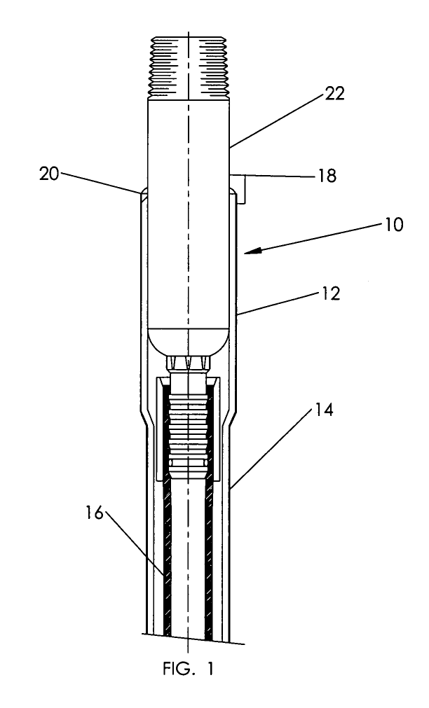

### DESCRIPTION OF THE PREFERRED EMBODIMENTS

Each embodiment of the current invention overcomes the foregoing problems associated with the prior art. Specifically, the current invention provides an adapter which is at least substantially non-corrosive, preferably a non-corrosive adapter, suitable for joining the plastic pipe used for underground distribution of natural gas to the metal pipe used for above ground distribution of natural gas. In the embodiments of the current invention, the protective metal casing does not act as a conduit for natural gas. Rather, in the current invention, the adapter provides for the transition from a subsurface plastic pipe to an above ground natural gas distribution system. Thus, the natural gas or other fluid passing through the subsurface distribution system is conveyed to the above ground distribution through the plastic pipe and the adaptor without contacting the interior of the protective metal casing. Accordingly, the current invention at least minimizes and preferably eliminates the hazard of leaks resulting from corrosion of the protective metal casing.

Additionally, except for the step of welding a connection ring to the casing in one embodiment of the current invention, conventional welding of the casing is not required for the purpose of securing the adaptor within the casing. Rather, in the current invention, the connection ring is welded to the casing prior to placement of the adapter and plastic pipe inside the casing. Thus, the entire external area of the casing, including the connection ring, may be coated with an epoxy corrosion resistant layer.

In the following discussion of the preferred embodiments, the plastic pipe is preferably polyethylene pipe as dictated by industry standards. The metal casing is preferably steel tubing and the protective corrosion resistant coating applied to the casing is preferably an epoxy both of which are well known to those skilled in the art. However, other materials may be readily substituted as will be recognized by one skilled in the art. Further, in one preferred embodiment, the adaptor is preferably manufactured from a non-ferrous metal. Preferably, the adaptor is manufactured from brass. As known to those skilled in the art, brass will corrode; however, the degree and rate of corrosion for brass will not impair the function of the current invention. For the purposes of this disclosure, materials manufactured from brass are considered to be examples of materials which are at least substantially non-corrosive, also known as corrosion resistant. Other substantially non-corrosive metals, non-ferrous metals or metallic compounds may also be used without departure from the current invention.

In another preferred embodiment, the adapter may be manufactured from non-metallic materials, such as thermoplastics, including but not limited to Nylon 11, Nylon 12 and thermoplastic blends of polyphenylene ether with either or both polystyrene and polypropylene such as the NORYL® family of polymers manufactured by GE Plastics. The foregoing materials may be reinforced with glass or fiber. Adapters manufactured from non-metallic materials of the type mentioned above will be non-corrosive and provide insulating properties to the corrosion resistant riser. As a further benefit, non-metallic adapters are cheaper to manufacture as machining and manufacturing costs will be substantially lower when compared to metallic adapters. Finally, adapters prepared from non-metallic materials will have configurations essentially identical to metallic adapters with only potential changes in wall thicknesses to ensure adequate strength.

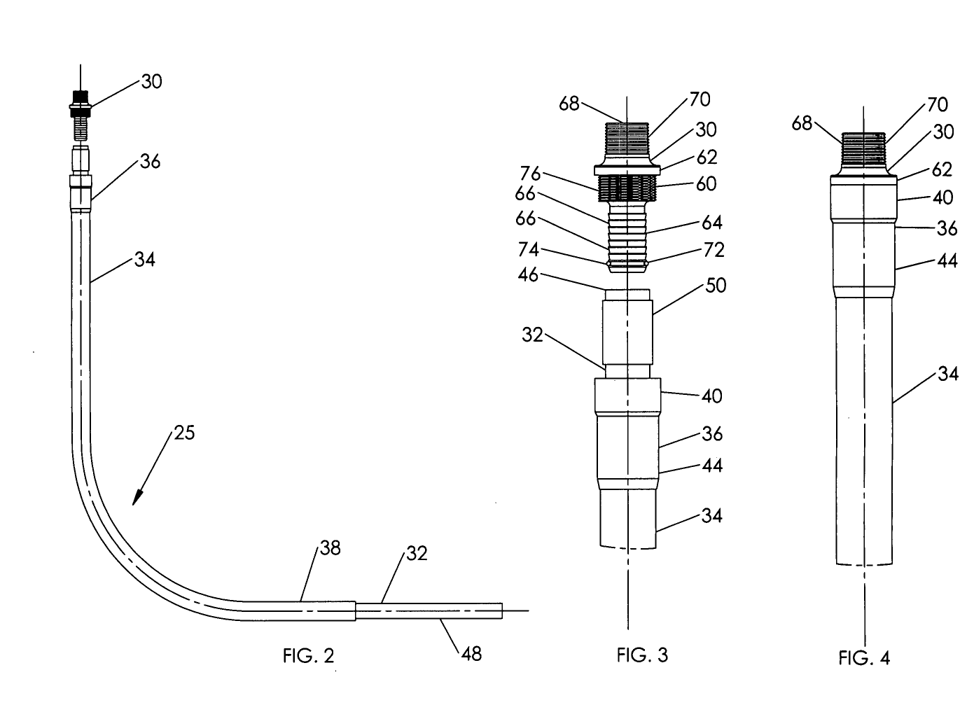

Turning first to the embodiment depicted in FIGS. 2-7, wherein like numbers refer to like components, the current invention provides a corrosion resistant gas service riser assembly 25. Gas service riser assembly 25 comprises an adapter 30 secured within a plastic pipe 32. Adapter 30 provides a transition from plastic pipe 32 found within assembly 25 to a metal pipe (not shown) typically associated with above ground natural gas distribution systems (not shown).

As depicted in FIG. 2, assembly 25 comprises an outer metallic corrosion resistant casing 34 having first and second ends 36, 38 and an interior passageway 39. As depicted in FIG. 2, casing 34 has an optional 90° curve or bend commonly used when assembly 25 is to be joined to an underground natural gas line (not shown). Assembly 25 provides a conduit from underground natural gas lines to a surface located gas meter or distribution system (not shown). As such, corrosion resistant casing 34 provides a protective shield for plastic pipe 32 located within passageway 39; however, casing 34 does not act as a conduit for fluid passing from the subsurface gas line to the surface located system.

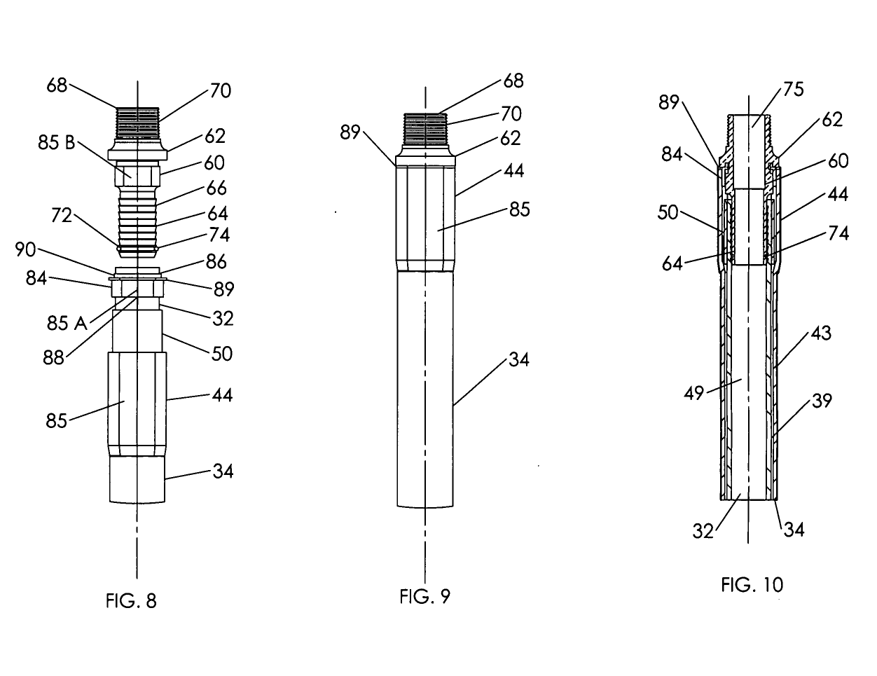

With reference to FIGS. 3-7, the details of improved corrosion resistant gas service riser assembly 25 and plastic to metal transition adapter 30 will be discussed. As shown in the Figs., first end 36 of corrosion resistant casing 34 optionally carries and includes a connection ring 40 having internal threads 42. Preferably connection ring 40 is welded to first end 36 of casing 34. Following welding of connection ring 40 to casing 34, a suitable corrosion resistant coating 43, such as fusion bonded epoxy, is applied to casing 34 and connection ring 40. Additionally, in the preferred embodiment, first end 36 of casing 34 has an enlarged diameter which is greater than the diameter of second end 38. This portion of first end 36 is known as a bellout area 44. Methods for creating bellout area 44 are well known to those skilled in the art and include among other techniques the use of an expanding mandrel. As an alternative to forming bellout area 44, connection ring 40 may have a length and diameter sufficient to substitute for bellout area 44. Further, if bellout area 44 is threaded or has a configuration as depicted in FIGS. 8-10, then connection ring 40 may be omitted.

As shown in FIG. 3, a first end 46 of plastic pipe 32 carries a compression sleeve 50. Compression sleeve 50 is sized to snuggly fit over first end 46 of plastic pipe 32. Preferably, the interior diameter of compression sleeve 50 substantially matches the external diameter of plastic pipe 32. Thus, insertion of an object into plastic pipe 32 which is slightly larger in diameter than the interior diameter of plastic pipe 32 will compress plastic pipe 32 against compression sleeve 50 thereby forming a secure fit. Finally, as shown in FIG. 2, second end 48 of plastic pipe 32 extends beyond second end 38 of corrosion resistant casing 34. In this manner, corrosion resistant gas surface riser assembly 25 is readily incorporated into underground gas lines by methods known to those skilled in the art.

Referring once again to FIGS. 3-5, the plastic to metal transition adapter 30 will be described. In one preferred embodiment, adapter 30 is at least substantially non-corrosive. More preferably, adapter 30 is non-corrosive. Adapter 30 has a body 60 carrying external threads 76. In the preferred embodiment, a flange 62 is carried by body 60 above threads 76; however, flange 62 may be omitted without reducing the operability of adaptor 30 for the purposes of this invention.

With reference to the Figs. a first nipple 64 preferably carrying a plurality of frusto-conically shaped rings 66 extends downward from body 60. Positioned above flange 62 is a second nipple 68 preferably carrying external threads 70. In the preferred embodiment, first nipple 64 carries a groove 72 with an o-ring 74 positioned therein. Finally, adapter 30 has a passageway 75 extending therethrough.

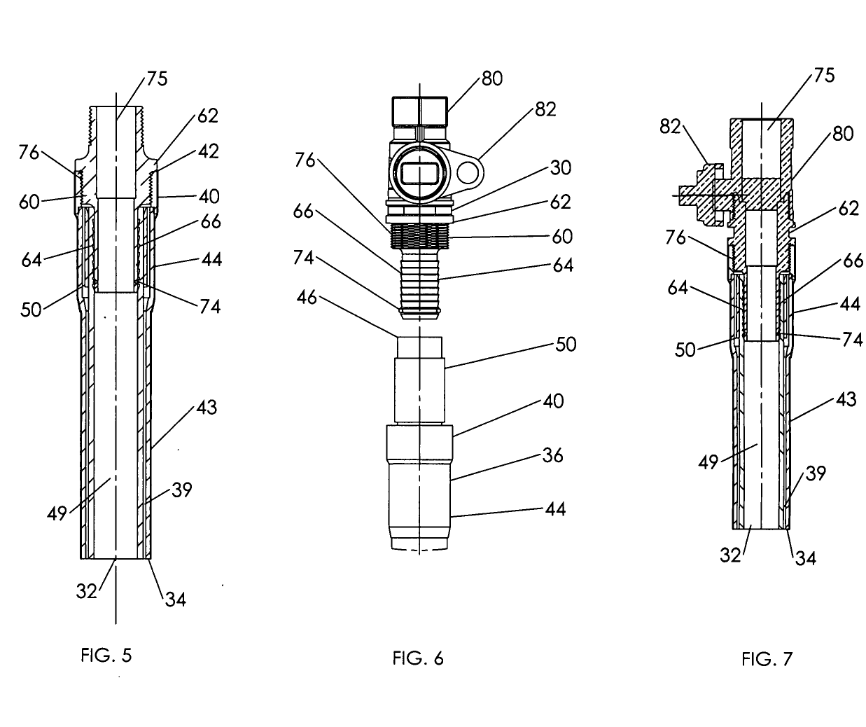

Referring now to FIGS. 4 and 5, first end 36 of the assembled corrosion resistant gas service riser assembly 25 is depicted. As depicted therein, first nipple 64 of the adapter 30 is positioned within a passageway 49 of plastic pipe 32 and secured therein by the compression sleeve 50. In the preferred embodiment, first nipple 64 has an exterior diameter slightly larger than the interior diameter of passageway 49. Thus, when fully assembled, frusto-conical rings 66 and the o-ring 74 in conjunction with compression sleeve 50 secure adapter 30 within plastic pipe 32. Further, threaded body 60 of adapter 30 is threaded into connection ring 40 carried by first end 36 of casing 34. In the preferred embodiment, threads 42 or threads 76 or both may be coated with a suitable adhesive for securing threaded body 60 within connection ring 40. In the preferred embodiment, corrosion resistant gas service riser assembly 25 is assembled prior to forming the bend within corrosion resistant casing 34. Finally, in the preferred embodiment, adapter 30 is secured within casing 34 and plastic pipe 32 in a manner sufficient to preclude fluid communication between interior passageway 39 of casing 34 and interior passageway 49 of plastic pipe 32.

Turning now to FIGS. 6 and 7, another embodiment of the current invention is depicted therein. In this embodiment, adapter 30 depicted in FIGS. 2-5 further incorporates an integral fitting 80. In the embodiment of FIGS. 6 and 7, integral fitting 80 is depicted as a valve 82; however, other fittings commonly employed in an aboveground natural gas distribution system may be incorporated into adapter 30 such as but not limited to unions (not shown).

Turning now to FIG. 8-10, an alternative embodiment of the current invention will be discussed. In this embodiment of the current invention, like numbers will be used to identify like components. As depicted in FIG. 8, bellout area 44 of corrosion resistant casing 34 has a geometrical configuration comprising at least one flat surface area 85. Preferably bellout area 44 has multiple flat surface areas 85 resembling wrench flats. However, it should be noted that flat surface areas 85 depicted thereon are not necessarily intended for engagement by a wrench. Methods for forming bellout area 44 of this configuration are well known to those skilled in the art and will not be discussed herein.

In this embodiment of the current invention, plastic pipe 32 passing through corrosion resistant casing 34 carries compression sleeve 50 and an insulated lock ring 84 on first end 46 thereof. Lock ring 84 is preferably manufactured from a non-conductive material such as, but not limited to, nylon or other suitable non-conductive plastics or non-conductive polymers. Preferably, lock ring 84 has a configuration corresponding to the configuration of bellout area 44. As such, lock ring 84 has at least one flat surface area 85a and preferably carries multiple flat surface areas 85a having the appearance of wrench flats. However, it should be noted that flat surface areas 85a depicted thereon are not necessarily intended for engagement by a wrench. Lock ring 84 has first and second open ends 86, 88 wherein second open end 88 has an internal diameter generally corresponding to the external diameter of plastic pipe 32 and first open end 86 has a diameter greater than the external diameter of the plastic pipe. Further, end 86 carries an outwardly extending flange 89. Preferably, outwardly extending flange 89 has an external diameter greater than the diameter defined by bellout area 44 of corrosion resistant casing 34. Finally, the insulated lock ring 84 has a body 90, which is preferably sized to fit within bellout area 44 of corrosion resistant casing 34.

Lock ring 84 provides several novel advantages to the current invention. First, in the preferred embodiment, lock ring 84 improves retention of adapter 30 within casing

In particular, the nested fitting of adapter 30 within lock ring 84 and lock ring 84 within bellout area 44 of casing 34 precludes undesired rotation of adapter 30. Further, following swaging, lock ring 84 is compressed against adapter 30 thereby enhancing retention of adapter 30 within casing 34. Finally, the insulating characteristics of lock ring 84 isolate adapter 30 from metal casing 34. Thus, lock ring 84 inhibits galvanic corrosion resulting from the contact of two dissimilar metals and thereby enhances the corrosion resistant characteristics of gas service riser assembly 25.

While lock ring 84 is preferably used in the configurations depicted in FIGS. 8-10, the current invention further contemplates use of lock ring 84 as a simple round ring (not shown) corresponding generally in configuration to bellout area 44 and adapter body 60. Typically, this embodiment will be used when the primary concern is precluding galvanic corrosion between adapter 30 and casing 34. When used as simple ring, preferably swaging or other similar joining method will be used to secure adapter 30 within casing 34.

In the embodiment of FIG. 8, adapter 30 comprises an adapter body 60 having an external configuration which corresponds to the configuration of bellout area 44 carried by corrosion resistant casing 34. As such, body 60 of the adapter 30 has at least one flat surface 85b and preferably has multiple flat surfaces 85b corresponding to wrench flats. However, it should be noted that flat surface areas 85b depicted thereon are not necessarily intended for engagement by a wrench. Preferably, body 60 is sized to fit within insulated lock ring 84 which in turn, as described above, fits within bellout area 44 of corrosion resistant casing 34. Thus, when assembled as depicted in FIGS. 9 and 10, corrosion resistant casing 34 may be swaged by applying pressure to lock ring 84 and adapter body 60 of the adapter 30. As such, adapter 30 is secured within corrosion resistant casing 34.

Finally, although not depicted in FIGS. 8-10, adapter 30 may further incorporate an integral fitting 80 as depicted in FIGS. 6 and 7. As discussed above such integral fittings 80 may include valves, swivels and unions.

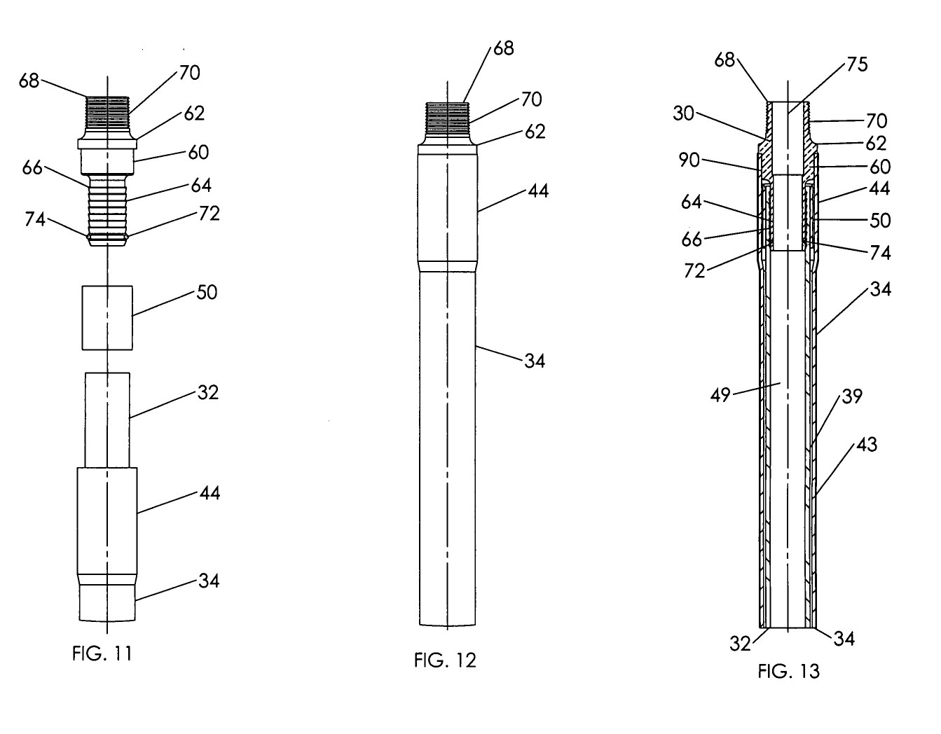

Another preferred embodiment of the current invention is depicted in FIGS. 11-13. In this embodiment, corrosion resistant casing 34 carries bellout area 44 as described above; however, connection ring 40 and flat surface areas 85 previously described have been omitted from bellout area 44 of casing 34. In this embodiment of the current invention, adapter 30 carries a flange 62 with adapter body 60 sized to be received within bellout area 44 of corrosion resistant casing 34. Preferably, body 60 of adapter 30 has an external diameter substantially similar to and preferably identical to the interior diameter of bellout area 44 carried by corrosion resistant casing 34.

As discussed above, adapter 30 has a first nipple 64 with a plurality of frusto-conically shaped rings 66 and o-ring 74 carried within groove 72 on first nipple 64. Nipple 64 is secured within plastic pipe 32 by compression sleeve 50 in the manner described above. Following positioning of adapter 30 within bellout area 44, the two components are joined by a magnetic pulse which creates a weld joint 92 between the two dissimilar metals sufficient to preclude fluid communication between interior passageway 39 of casing 34 and interior passageway 49 of plastic pipe 32. The process of magnetic pulse welding is well known to those skilled in the art as described by the following U.S. Patents which are incorporated herein by reference:U.S. Pat. Nos. 5,824,998; 6,229,125; and, 6,630,649. Magnetic pulse welding devices are readily available from Pulsar Welding Ltd.

Accordingly, in this embodiment of the current invention corrosion resistant gas service riser assembly 25 comprises metallic corrosion resistant casing 34 preferably formed from a ferrous material such as steel. Casing 34 carries an external coating 43 of corrosion resistant material such as epoxy or other material and natural gas carrying plastic pipe 32 passes therethrough terminating at first end 46 with adapter 30. Second end 48 of plastic pipe 32 extends beyond second end 38 of casing 34 to permit tie-in with an underground natural gas distribution system (not shown). Preferably, adapter 30 is prepared from brass or other substantially non-corrosive metal or a non-corrosive plastic as described above. Adapter 30 is secured within plastic pipe 32 by compression sleeve 50 and within corrosion resistant casing 34 by weld 92.

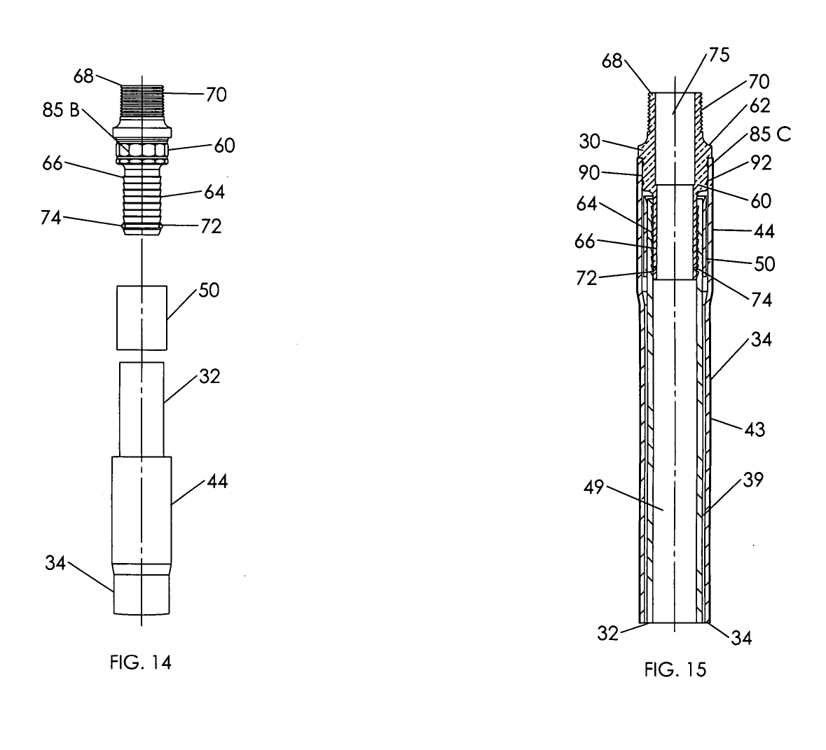

An alternative embodiment of the invention depicted in FIGS. 11-13 is provided by FIGS. 14-15. As in the embodiment of FIGS. 11-13, flat surface areas 85 previously described have been omitted from bellout area 44 of casing 34. In this embodiment of the current invention, body 60 carried by adapter 30 has at least one flat surface area 85b and preferably has multiple flat surface areas 85b corresponding to wrench flats. However, it should be noted that flat surface areas 85b depicted thereon are not necessarily intended for engagement by a wrench. Rather, the appearance resembles wrench flats with the primary purpose being to provide multiple flat surface areas 85b for engagement by bellout area 44 of corrosion resistant casing 34. Methods such as polycutting, milling and forging for forming flat surface areas 85c on body 60 are well known to those skilled in the art.

In this embodiment of the current invention, body 60 of adapter 30 has an overall external diameter substantially similar to and preferably identical to the interior diameter of bellout area 44 carried by first end 36 of corrosion resistant casing 34. When assembled as depicted in FIG. 15, adapter 30 may be secured within bellout area 44 by swaging using techniques known to those skilled in the art. Alternatively, magnetic pulse technology may be used to secure the adapter within the corrosion resistant casing. Both techniques for securing adaptor 30 within bellout area 44 are sufficient to preclude fluid communication between interior passageway 39 of casing 34 and interior passageway 49 of plastic pipe 32

Assembly of corrosion resistant gas service riser assembly 25 is substantially similar for each of the preferred embodiments of the current invention discussed above. The primary difference in the assembly process relates to the desired method for securing adapter 30 within bellout area 44 of corrosion resistant casing 34.

In general, the assembly process begins with providing corrosion resistant casing 34 as a straight pipe having first and second ends 36, 38. Bellout area 44 is formed on first end 36 and, if used, connection ring 40 is welded thereto. Subsequently, plastic pipe 32 is positioned within passageway 39 of corrosion resistant casing 34 and compression sleeve 50 positioned on first end 46 of plastic pipe 32. Further, if used, insulated lock ring 84 is positioned on first end 46 of plastic pipe 32 above compression sleeve 50. Subsequently, plastic pipe 32 is secured and adapter 30, as described above, is pressed into plastic pipe 32. Compression sleeve 50 is then slid upwards over the area defined by the first nipple 64 of adapter 30. Alternatively, adapter 30 may be secured to plastic pipe 32 prior to placing pipe 32 and adapter 30 within casing 34. Methods for positioning adapter 30 within plastic pipe 32 and subsequently moving compression sleeve 50 into position are well known to those skilled in the art and will not be discussed herein.

After adapter 30 has been secured within plastic pipe 32, adapter 30 is subsequently secured within corrosion resistant casing 34 in a manner sufficient to preclude fluid communication between interior passageway 39 of casing 34 and interior passageway 49 of plastic pipe 32. As discussed above, adapter 30 may be positioned and secured within connection ring 40 or threaded bellout area 44 by threading adapter 30 therein with the optional use of an adhesive. When properly positioned, flange 62 preferably contacts first end 36 of casing 34. As noted above, first end 36 includes bellout area 44 and optional connection ring 40. Alternatively, adapter body 60 is positioned within lock ring 84 and subsequently slid into position within corrosion resistant casing 34. Adapter 30 is secured therein by a swaging process known to those skilled in the art. As another alternative when lock ring 84 is omitted, adapter 30 is secured within casing 34 by a magnetic pulse weld or pulse formed deformation of casing 34. Finally, any bends required in corrosion resistant casing 34 are preferably formed following securing of adapter 30 within corrosion resistant casing 34.

The current invention also provides a method for joining underground fluid distribution systems, such as natural gas, with above ground distribution systems. As previously noted many underground natural gas distribution systems utilize plastic pipe. Therefore, integration of the underground distribution systems with the above ground distribution systems requires a riser incorporating a suitable adapter for joining the plastic pipe to the above ground metal pipe distribution system. In the preferred embodiment of the method of the current invention, gas service riser assembly 25 is manufactured as described above. Following incorporation of any necessary bends within riser assembly 25, second end 48 of plastic pipe 32 is spliced into the underground distribution system using methods known to those skilled in the art. Additionally, fitting 80 or valve 82 carried by adaptor 30 is joined directly or indirectly, i.e. through another fitting (not shown), to the above ground distribution system.

Other embodiments of the current invention will be apparent to those skilled in the art from a consideration of this specification or practice of the invention disclosed herein. Thus, the foregoing specification is considered merely exemplary of the current invention with the true scope and spirit of the invention being indicated by the following claims.

We claim:

1. A corrosion resistant gas service riser assembly comprising:
a corrosion resistant casing having an interior passageway and first and second ends;
a plastic pipe having an interior passageway and first and second ends positioned within said interior passageway of said casing;
an adapter having a body, extending from said body is a first nipple, said first nipple is positioned within said plastic pipe; and, wherein said body of said adapter is secured within said first end of said corrosion resistant casing thereby precluding fluid communication between the interior passageway of said plastic pipe and the interior passageway of said casing.

2. The corrosion resistant gas service riser assembly of claim 1, further comprising a compression sleeve carried by said first end of said plastic pipe and wherein said compression sleeve secures said first nipple within said plastic pipe.

3. The corrosion resistant gas service riser assembly of claim 1, wherein said first end of said casing carries a bellout area and said body of said adapter is secured with said bellout area.

4. The corrosion resistant gas service riser assembly of claim 1, further comprising an integral fitting carried by said adapter, said fitting carried on the opposite side of said body from said first nipple.

5. The corrosion resistant gas service riser assembly of claim 1, wherein said adapter is prepared from materials selected from the group consisting of, Nylon 11, Nylon 12, substantially non-corrosive metals, thermoplastic blends of polyphenylene ether with either or both polystyrene and polypropylene and combinations thereof.

6. The corrosion resistant gas service riser assembly of claim 1, wherein said body of said adapter carries a flange.

7. The corrosion resistant gas service riser assembly of claim 1, further comprising a ring carried by said first end of said plastic pipe, said ring having first and second open ends joined by a body sized to be received within the first end of said casing, wherein said ring is manufactured from a material suitable for inhibiting galvanic corrosion of said adapter and said casing.

8. A corrosion resistant gas service riser assembly comprising:
a corrosion resistant casing having an interior passageway and first and second ends;
a bellout area carried by said first end of said casing;
a plastic pipe having an interior passageway and first and second ends positioned within said interior passageway of said casing; and,
an adapter having a body, extending from said body is a first nipple, said first nipple is positioned within said plastic pipe and wherein said body of said adapter is secured within said bellout area thereby precluding fluid communication between the interior passageway of said plastic pipe and the interior passageway of said casing.

9. The corrosion resistant gas service riser assembly of claim 8, further comprising a compression sleeve carried by said first end of said plastic pipe and wherein said compression sleeve secures said first nipple within said plastic pipe.

10. The corrosion resistant gas service riser assembly of claim 8, wherein said bellout area further comprises a connection ring, wherein said connection ring carries internal threads and said body of said adapter carries external threads; and, wherein said external threads of said adapter engage said internal threads of said connection ring.

11. The corrosion resistant gas service riser assembly of claim 8, wherein at least a portion of said bellout area is formed by a connection ring secured to said bellout area.

12. The corrosion resistant gas service riser assembly of claim 8, further comprising an integral fitting carried by said adapter, said fitting carried on the opposite side of said body from said first nipple.

13. The corrosion resistant gas service riser assembly of claim 8, wherein said adapter is prepared from materials selected from the group consisting of, Nylon 11, Nylon 12, substantially non-corrosive metals, thermoplastic blends of polyphenylene ether with either or both polystyrene and polypropylene and combinations thereof.

14. The corrosion resistant gas service riser assembly of claim 8, wherein said body of said adapter carries a flange.

15. The corrosion resistant gas service riser assembly of claim 8, further comprising a ring carried by said first end of said plastic pipe, said ring having first and second open ends joined by a body sized to be received within the first end of said casing, wherein said ring is manufactured from a material suitable for inhibiting galvanic corrosion of said adapter and said casing.

16. A corrosion resistant gas service riser assembly comprising:
a corrosion resistant casing having an interior passageway and first and second ends wherein said first end includes a bellout area, said bellout area carries internal threads;
a plastic pipe having an interior passageway and first and second ends positioned within said interior passageway of said casing, said second end of said plastic pipe extends through said second end of said casing;
a compression sleeve carried by said first end of said plastic pipe, said compression sleeve having an internal diameter substantially similar to the external diameter of said plastic pipe; and,
an at least substantially non-corrosive adapter having a threaded body, extending downward from said threaded body is a first nipple, said first nipple carries a groove for receiving an o-ring, extending upward from said body is a second nipple, wherein said first nipple is positioned within said plastic pipe and secured therein by said compression sleeve and wherein said threaded body is threaded into said bellout area thereby precluding fluid communication between the interior of said plastic pipe and the interior of said casing.

17. The corrosion resistant gas service riser of claim 16, wherein a connection ring forms at least part of said bellout area, said connection ring carries internal threads suitable for receiving said threaded body of said adapter.

18. The corrosion resistant gas service riser assembly of claim 16, further comprising an integral fitting carried by said adapter, said fitting being secured to said second nipple.

19. The corrosion resistant gas service riser assembly of claim 16, wherein said adapter is prepared from materials selected from the group consisting of, Nylon 11, Nylon 12, substantially non-corrosive metals, thermoplastic blends of polyphenylene ether with either or both polystyrene and polypropylene and combinations thereof.

20. The corrosion resistant gas service riser assembly of claim 16, wherein said body of said adapter carries a flange.

21. The corrosion resistant gas service riser assembly of claim 16, further comprising a ring carried by said first end of said plastic pipe, said ring having first and second open ends joined by a body sized to be received within the first end of said casing, wherein said ring is manufactured from a material suitable for inhibiting galvanic corrosion of said adapter and said casing.

22. A corrosion resistant gas service riser assembly comprising:
a corrosion resistant casing having an interior passageway and first and second ends;
a corrosion resistant connection ring welded to said first end of said casing, said connection ring carrying internal threads;
a plastic pipe having an interior passageway and first and second ends positioned within said interior passageway of said casing, said second end of said plastic pipe extends through said second end of said casing; and,
an adapter including an integral fitting, said adapter having a threaded body, said threads having a pitch corresponding to said internal threads carried by said connection ring, extending downward from said threaded body is a nipple, said threaded body carries an integral fitting opposite from said nipple, wherein said nipple is positioned within said plastic pipe and secured therein and wherein said threaded body is threaded into said connection ring.

23. The corrosion resistant gas service riser assembly of claim 22, further comprising a compression sleeve carried by said first end of said plastic pipe and wherein said compression sleeve secures said first nipple within said plastic pipe.

24. The corrosion resistant gas service riser assembly of claim 22, wherein said first end of said casing carries a bellout area and said connection ring forms at least part of said bellout area.

25. The corrosion resistant gas service riser assembly of claim 22, wherein said adapter is prepared from materials selected from the group consisting of, Nylon 11, Nylon 12, substantially non-corrosive metals, thermoplastic blends of polyphenylene ether with either or both polystyrene and polypropylene and combinations thereof.

26. The corrosion resistant gas service riser assembly of claim 22, wherein said body of said adapter carries a flange.

27. The corrosion resistant gas service riser assembly of claim 22, further comprising a ring carried by said first end of said plastic pipe, said ring having first and second open ends joined by a body sized to be received within the first end of said casing, wherein said ring is manufactured from a material suitable for inhibiting galvanic corrosion of said adapter and said casing.

28. A corrosion resistant gas service riser assembly comprising:
a corrosion resistant casing having an interior passageway and first and second ends;
a plastic pipe having an interior passageway and first and second ends positioned within said interior passageway of said casing;
a ring carried by said first end of said plastic pipe and positioned with said first end of said casing, said ring having first and second open ends joined by a body sized to be received within the first end of said casing, wherein said first open end of said ring has an internal diameter greater than the external diameter of said plastic pipe and said second open end of said ring has an internal diameter corresponding generally to the external diameter of said plastic pipe; and,
an at least substantially non-corrosive adapter said adapter body being sized to be received within said first end of said ring and said adapter body having a first nipple extending downwardly therefrom, wherein said first nipple is positioned within said plastic pipe and wherein said adapter body is positioned within said ring and secured within said first end of said casing thereby precluding fluid communication between the interior of said plastic pipe and the interior of said casing.

29. The corrosion resistant gas service riser assembly of claim 28, further comprising a compression sleeve carried by said first end of said plastic pipe and wherein said compression sleeve secures said first nipple within said plastic pipe.

30. The corrosion resistant gas service riser assembly of claim 28, wherein said first end of said casing has a diameter larger than the diameter of said second end and wherein said first end has a configuration corresponding to wrench flats.

31. The corrosion resistant gas service riser assembly of claim 28, wherein said ring has an external configuration corresponding to said wrench flats carried by the first end of said casing.

32. The corrosion resistant gas service riser assembly of claim 31, wherein said adapter body has an external configuration corresponding to wrench flats.

33. The corrosion resistant gas service riser assembly of claim 28, wherein said ring is manufactured from a material suitable for inhibiting galvanic corrosion of said adapter.

34. The corrosion resistant gas service riser assembly of claim 28, wherein said adapter is prepared from materials selected from the group consisting of, Nylon 11, Nylon 12, substantially non-corrosive metals, thermoplastic blends of polyphenylene ether with either or both polystyrene and polypropylene and combinations thereof.

35. The corrosion resistant gas service riser assembly of claim 28, wherein said body of said adapter carries a flange.

36. A corrosion resistant gas service riser assembly comprising:
a corrosion resistant casing having an interior passageway and first and second ends, said first end having a diameter larger than the diameter of said second end and wherein said first end has a configuration corresponding to wrench flats;
a plastic pipe having an interior passageway and first and second ends positioned within said interior passageway of said casing;
a compression sleeve carried by said first end of said plastic pipe, said compression sleeve having an internal diameter substantially similar to the external diameter of said plastic pipe;
a lock ring carried by said first end of said plastic pipe and positioned with said first end of said casing, said lock ring having a body with an external configuration corresponding to said wrench flats carried by said first end of said casing and being sized to be received within the first end of said casing, said lock ring body extending between a first open end and a said second open end, wherein said first open end carries an outwardly extending flange and wherein said first open end of said lock ring has an internal diameter greater than the external diameter of said plastic pipe and said second open end of said lock ring has an internal diameter corresponding generally to the external diameter of said plastic pipe; and,
an at least substantially non-corrosive adapter having an adapter body said adapter body having an external configuration corresponding to wrench flats, said adapter body being sized to be received within said insulated lock ring and said adapter body having a first nipple extending downwardly therefrom, wherein said first nipple is positioned within said plastic pipe and secured therein by said compression sleeve and wherein said adapter body is positioned within said insulated lock ring and secured within said first end of said casing thereby precluding fluid communication between the interior of said plastic pipe and the interior of said casing.

37. The corrosion resistant gas service riser assembly of claim 36, wherein said adapter is prepared from materials selected from the group consisting of, Nylon 11, Nylon 12, substantially non-corrosive metals, thermoplastic blends of polyphenylene ether with either or both polystyrene and polypropylene and combinations thereof.

38. The corrosion resistant gas service riser assembly of claim 36, wherein said body of said adapter carries a flange.

39. The corrosion resistant gas service riser assembly of claim 36, wherein said lock ring is manufactured from a material suitable for inhibiting galvanic corrosion of said adapter.

40. A corrosion resistant gas service riser assembly comprising:
a corrosion resistant casing having an interior passageway and first and second ends;
a plastic pipe having an interior passageway and first and second ends positioned within said interior passageway of said casing;
an adapter having a body, extending from said body is a first nipple, said first nipple is positioned within said plastic pipe and secured therein, said adapter body is sized to be received within said first end of said casing; and,
a magnetic pulse type weld joint or a swaged joint secures said adapter to said first end of said casing thereby precluding fluid communication between the interior of said plastic pipe and the interior of said casing.

41. The corrosion resistant gas service riser assembly of claim 40, wherein said adapter is prepared from materials selected from the group consisting of, Nylon 11, Nylon 12, substantially non-corrosive metals, thermoplastic blends of polyphenylene ether with either or both polystyrene and polypropylene and combinations thereof.

42. The corrosion resistant gas service riser assembly of claim 40, wherein said body of said adapter carries a flange.

43. A method for joining an underground fluid distribution system to an above ground distribution system comprising the steps of:
providing a casing having an interior passageway and first and second ends;
providing a plastic pipe having an interior passageway and first and second ends;
providing a plastic pipe to metal pipe adapter, said adaptor having a body sized to fit within said casing, extending from said body is a first nipple, on the opposite side of said body from said first nipple is a fitting suitable for integration with an above ground distribution system;
securing said first nipple within said first end of said plastic pipe;
positioning said plastic pipe within said interior passageway of said casing, said plastic pipe having a length sufficient such that the second end of said plastic pipe extends beyond the second end of said casing;
positioning and securing said body of said adaptor within the first end of said casing in a manner sufficient to preclude fluid communication between the interior of said plastic pipe and the interior of said casing;
joining said second end of said plastic pipe to an underground fluid distribution system; and,
joining said fitting directly or indirectly to an above ground distribution system.

44. The method of claim 43, further comprising the step of forming a bellout area on the first end of said casing, wherein said step of forming a bellout area further includes the step of welding a connection ring to said first end of said casing, said connection ring having internal threads.

45. The method of claim 44, wherein said body of said adapter carries a flange and said body carries external threads suitable for engaging said internal threads carried by said connection ring and wherein said step of securing said body of said adapter within said casing further comprises the step of threading said body into said connection ring until said flange contacts said connection ring.

46. The method of claim 43, wherein said step of securing said body within said first end of said casing comprises the step of swaging said casing.

47. The method of claim 43, wherein said step of securing said body within said first end of said casing comprises the step of magnetically pulse welding said casing to said body.

48. The method of claim 43, wherein said body of said adapter carries a flange and wherein said step of securing said adapter within said casing further comprises the step of inserting said body into said casing until said flange contacts said first end of said casing.
